(19) United States
(12) Patent Application Publication
(10) Pub. No.: US 2014/0047361 A1
(43) Pub. Date: Feb. 13, 2014

(54) SCREEN DEVICE FOR INTERACTING WITH A MULTI-LEVEL HIERARCHY

(71) Applicants: Brian GASPAR, Mountain View, CA (US); Anil SUDHAKARAN, Irvine, CA (US); Appla J. PADALA, Irving, TX (US); Hari G. NAIR, Thiruvananthapuram (IN); Makoto ISHIJIMA, Haymarket (AU)

(72) Inventors: Brian GASPAR, Mountain View, CA (US); Anil SUDHAKARAN, Irvine, CA (US); Appla J. PADALA, Irving, TX (US); Hari G. NAIR, Thiruvananthapuram (IN); Makoto ISHIJIMA, Haymarket (AU)

(73) Assignee: Oracle International Corporation, Redwood Shores, CA (US)

(21) Appl. No.: 13/569,700

(22) Filed: Aug. 8, 2012

(51) Int. Cl. G06F 3/01

(52) U.S. Cl. 715/762

(57) ABSTRACT

A method, system, and computer program product for a human-computer graphical interface device for interacting with a multi-level hierarchy. The method commences by receiving a hierarchy data structure that describes a plurality of adjacent hierarchical levels, from which are selected three adjacent levels, which in turn are used in forming a graphical screen device having three or more three concentric annular areas, each one of the concentric areas corresponding to a respective level of the hierarchy. Each one of the concentric areas is populated with icons or other screen devices, and the icons are annotated with aspects of node information pertaining to a node at the respective level. The annular areas can be formed by circle shapes and/or by ring shapes. The organization of the rings corresponds to adjacent levels of the hierarchy such that each larger ring corresponds to a successively next lower level of the hierarchy.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of human-computer graphical interface devices and more particularly to techniques for interacting with a multi-level hierarchy.

### BACKGROUND

Some embodiments of the present disclosure are directed to an improved approach for implementing a human interface screen device for interacting with a multi-level hierarchy.

A traditional hierarchical structure (e.g., organizational chart or sales catalog) displayed on a traditional desktop web-based application have only limited user views and interactions with hierarchical structures. For example, legacy GUI interfaces using depictions of “boxes and lines”, shapes, and other screen display devices have delivered only a limited ability to navigate a hierarchy (up/down and left/right) and take actions on a node in the hierarchy, for example, by clicking on a node or shape or (for example) by selecting one from among many possible actions through a drop-down menu corresponding clicked-on node.

This type of legacy web-based interaction does not fit the usage patterns as are typical on a tablet device, at least because the screen size of a tablet is generally significantly smaller than that of a desktop monitor or laptop screen. For example, many iPad™ devices have a 9.7 inch screen versus the average 20 inch monitor for a desktop computer or 16 inch screen for a laptop computer.

Furthermore, typical usage patterns on a tablet device requires that:
Task specific interactions occur all on the same page.
The GUI interaction with a page (e.g., select operations, navigation operations, etc.) need to support gestures from human fingers, rather than clicks from a mouse or other pointing devices.

Legacy screen devices fail to address the problem of how to display, interact and respond to user interaction with computer-aided responses. Moreover the legacy screen devices fail to provide ease-of-interaction in and through hierarchies when used on a tablet device, especially tablet devices supporting multi-touch gestures on a touch screen.

Moreover, the aforementioned technologies do not have the capabilities to perform functions on a human interface screen device for interacting with a multi-level hierarchy. Therefore, there is a need for an improved approach.

### SUMMARY

The present disclosure provides an improved method, system, and computer program product suited to address the aforementioned issues with legacy approaches. More specifically, the present disclosure provides a detailed description of techniques used in methods, systems, and computer program products for a human interface screen device for interacting with a multi-level hierarchy.

Disclosed herein are methods and systems for making and using a human-computer graphical interface (e.g., a GUI) for interacting with a multi-level hierarchy. The method commences by receiving a hierarchy data structure that describes a plurality of adjacent hierarchical levels, from which are selected three adjacent levels, which in turn are used in forming a graphical screen device having three or more three concentric annular areas, each one of the concentric annular areas corresponding to a respective level of the hierarchy. Each one of the concentric annular areas is populated with icons or other screen devices, and the icons are annotated with aspects of node information pertaining to a node at the respective level. The annular areas can be formed by circle shapes and/or by ring shapes. The organization of the rings corresponds to adjacent levels of the hierarchy such that each larger ring corresponds to a successively next lower level of the hierarchy.

Further details of aspects, objectives, and advantages of the disclosure are described below in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A is a chart showing a data flow to implement a human interface screen device for interacting with a multi-level hierarchy, according to some embodiments.

FIG. 1B is a flow chart showing a data flow technique to implement a human interface screen device for interacting with a multi-level hierarchy, according to some embodiments.

FIG. 2 is an annotated hierarchy diagram as used in systems to implement a human interface screen device for interacting with a multi-level hierarchy, according to some embodiments.

FIG. 3 depicts a partially populated hierarchy spinner displayed with a gesture suggestion on a touch-screen display surface used in systems having a human interface screen device for interacting with a multi-level hierarchy, according to some embodiments.

FIG. 4 depicts a hierarchy spinner displaying node data based on user gestures as depicted on a display surface used in systems having a human interface screen device for interacting with a multi-level hierarchy, according to some embodiments.

FIG. 5 depicts a hierarchy spinner displayed with computer-generated data representations shown on a display surface used in systems having a human interface screen device for interacting with a multi-level hierarchy, according to some embodiments.

FIG. 6 depicts a hierarchy spinner displayed with side-by-side comparisons and animations upon a display surface used in systems having a human interface screen device for interacting with a multi-level hierarchy, according to some embodiments.

FIG. 7 depicts a hierarchy spinner displayed with computer-generated reports shown on a display surface used in systems having a human interface screen device for interacting with a multi-level hierarchy, according to some embodiments.

FIG. 8 depicts a hierarchy spinner displayed with an underlying page on a display surface used in systems having a human interface screen device for interacting with a multi-level hierarchy, according to some embodiments.

FIG. 9 depicts a block diagram of a system to perform certain functions of a computer system, according to some embodiments.

FIG. 10 depicts a block diagram of an instance of a computer system suitable for implementing an embodiment of the present disclosure.

### DETAILED DESCRIPTION

Some embodiments of the present disclosure are directed to an improved approach for implementing a human interface screen device for interacting with a multi-level hierarchy. More particularly, disclosed herein are environments, methods, and systems for implementing a human interface screen device for interacting with a multi-level hierarchy.

### Overview

The herein-disclosed screen device for interacting with a multi-level hierarchy (e.g., hierarchy spinner) delivers:
A visual representation of a hierarchical structure that fits within the limited screen size of a tablet.
A navigable and actionable hierarchy driven by a user's fingers and gestures.
Multiple “spinnable” rings representing levels of the hierarchy so that users can see additional nodes that do not fit on a tablet's smaller screen.
A semi-transparent page overlay so that the user can see hierarchy node data and interact with it (e.g., tap a box in an org chart and details appear overlaying the hierarchy).

### DESCRIPTIONS OF EXEMPLARY EMBODIMENTS

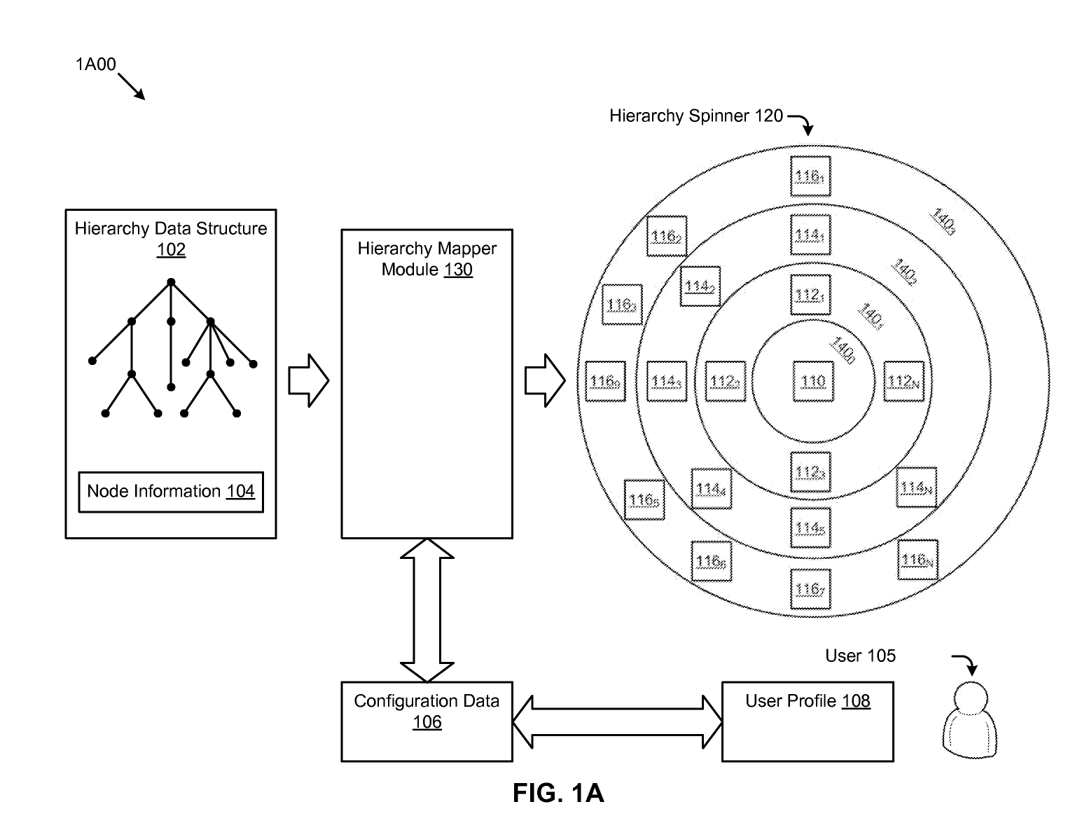

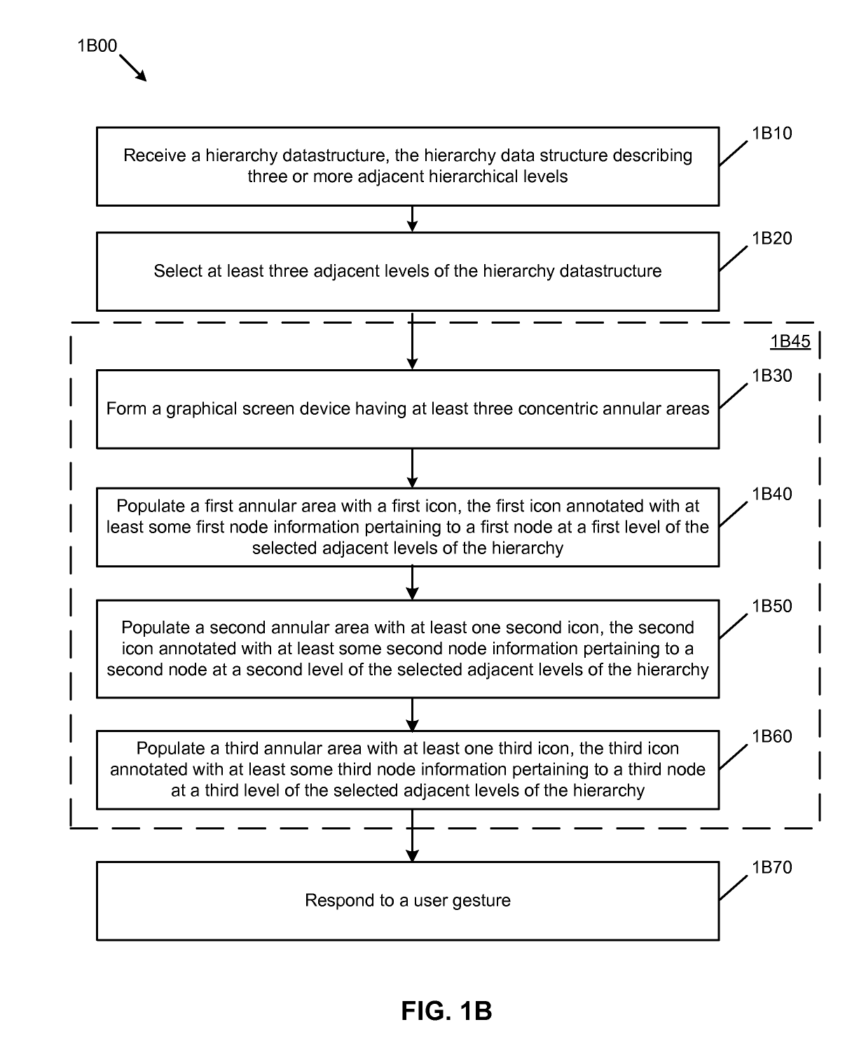

FIG. 1A is a chart showing a data flow 1A00 to implement a human interface screen device for interacting with a multi-level hierarchy. As an option, the present data flow 1A00 may be implemented in the context of the architecture and functionality of the embodiments described herein. Also, the data flow 1A00 or any aspect therein may be implemented in any desired environment.

As shown, a screen device (e.g., hierarchy spinner 120) is formed by a hierarchy mapper module 130. The hierarchy mapper module 130 in turn receives all or part of a hierarchy data structure 102 and configuration data 106. For example, the hierarchy data structure 102 can be embodied as a directed graph (as shown) or as a tree, or one or more relations in a relational database. In exemplary embodiments, the hierarchy data structure 102 comprises node information 104, which node information codifies any sort of information pertaining to any node in the hierarchy.

Strictly as an example, the hierarchy data structure 102 can comprise an “org chart” of a hierarchically-structured organization of people, and the node information can comprise biographical data of each of the people in the org chart. Further, the configuration data can comprise any sort of information pertaining to the look and feel of the hierarchy spinner 120 such as dimensions, look-and-feel of the screen device, and possibly, the configuration data and/or user profile 108 can comprise a library of screen device components (e.g., subroutines, Java classes, method, etc.).

### Data Retrieval and Caching

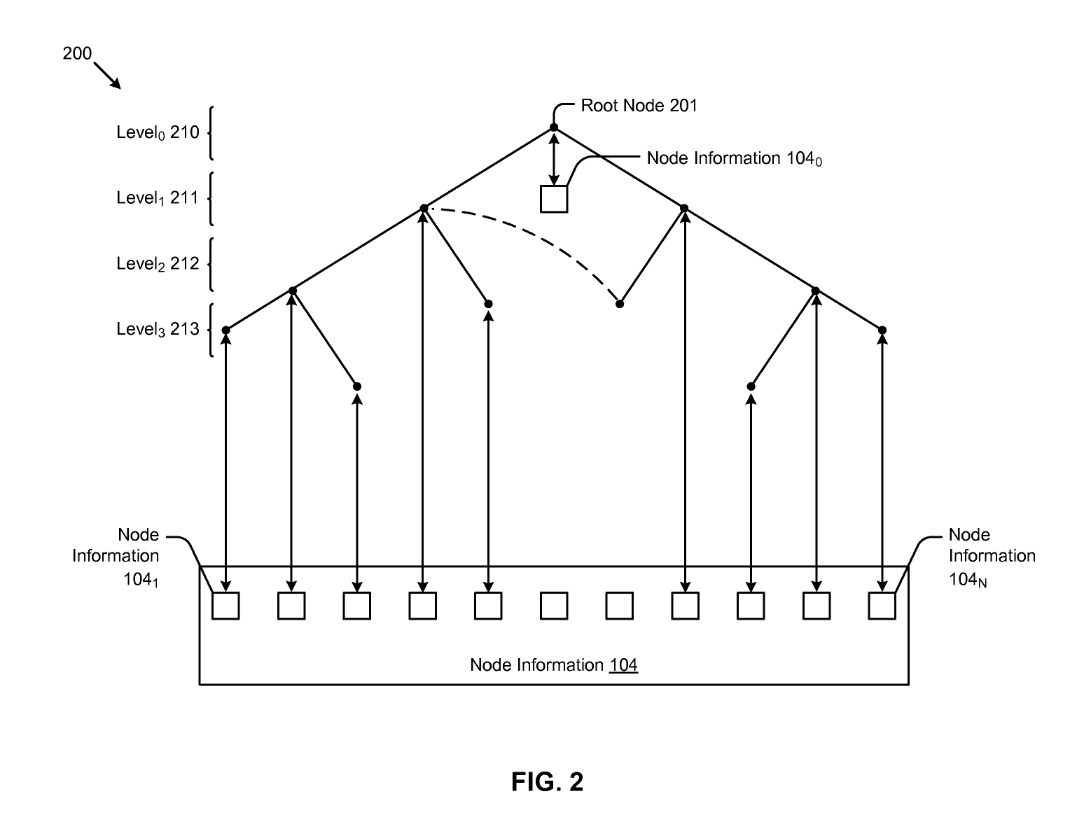

Following the above-described specific embodiment involving an org chart of a hierarchical organization, data retrieval proceeds as follows:
The hierarchy mapper module 130 retrieves a hierarchy data structure 102 and node information 104, as well as configuration data 106. The hierarchy mapper module 130 can retrieve such data structures and corresponding information from a database, or from a web service, or from a locally cached data source. Further examples are presented in the discussion of FIG. 2, infra
Nodes found in the hierarchy data structure are assigned to a functional object (e.g., an avatar or icon) and the avatar or icon is displayed so as to represent the node in the hierarchy. For example, an icon or other screen object (e.g., icon 110, icon 112, icon 114, icon 116, etc.) can be selected to represent a person, or product, etc.
Nodes in the form of an avatar or icon are added in predetermined positions on one of the spinnable rings (e.g., annular area 140₀, annular area 140₁, annular area 140₂, annular area 140₃, etc.). The position of the initial placement of the avatars is based on the person's position in the depicted organization hierarchy.
   Interacting with a Hierarchy Spinner

In some situations, a hierarchy spinner is initially displayed in a collapsed form (e.g., as a hierarchy spinner icon). In such as case, a user 105 might indicate intent to interact with the hierarchy spinner by using a multi-touch gesture to “open” the hierarchy spinner. Examples of gestures to expand a collapsed hierarchy spinner include:
Single tap on the spinner icon
Single tap on an icon or menu item (e.g., organization icon) in a toolbar or menu banner.

### Animations

Following the aforementioned gesture to expand a hierarchy spinner from a collapsed state, a hierarchy spinner will open on the screen and multiple levels (e.g., three or four levels, as shown). Strictly as an example, the “open” action can be animated such that upon opening, the hierarchy spinner will “spin in” from top right to bottom right. In another animation, a rotation animation of 360 degrees is applied to the “spinnable” views to provide a visual cue to the user that the user can spin it with a gesture.

In addition to the display of the hierarchy spinner with its look-and-feel characteristics, exemplary hierarchy spinner implementations are populated with node data in order to aid the user in operation for moving through, interacting with, and analyzing the hierarchy data structure.

FIG. 1B is a flow chart 1B00 showing a data flow technique to implement a human interface screen device for interacting with a multi-level hierarchy. The above descriptions have included examples of hierarchical data structures that represent org charts; however the hierarchy mapper module 130 and hierarchy spinner 120 are flexible so as to operate with a wide range of node types as represented in one or more hierarchies and corresponding node data.

A hierarchy spinner can be formed by receiving a hierarchy data structure (see operation 1B10) and the hierarchy data structure can describe any number of adjacent hierarchical levels of nodes, where the nodes can represent any entity, and the hierarchical juxtaposition of the nodes is represented by the node's position in the hierarchy. In some cases a hierarchy can be a tree, or can be a directed graph.

At least for initial display, a hierarchy mapper module 130 might serve to initially select nodes from at least three adjacent levels of the hierarchy data structure (see operation 1B20), and based on the hierarchical juxtaposition of the selected nodes, the hierarchy mapper module 130 can compose or form a graphical screen device (see operation 1B30), the screen device having at least three concentric annular areas (e.g., as shown in FIG. 1A), and then populating a first annular area with a first icon, the first icon annotated with at least some first node information pertaining to a first node at a first level of the selected adjacent levels of the hierarchy (see operation 1B40), then populating a second concentric area with at least one second icon, the second icon annotated with at least some second node information pertaining to a second node at a second level of the selected adjacent levels of the hierarchy (see operation 1B50), and populating a third annular area with at least one third icon, the third icon annotated with at least some third node information pertaining to a third node at a third level of the selected adjacent levels of the hierarchy (see operation 1B60). Having composed the screen device, the data flow technique 1B00 commences to respond to user gestures (see operation 1B70). Any organization or program code can implement a construction method 1B45 (e.g., a subroutine or a Java class, etc.), and such a construction method 1B45 can be used conveniently by a computer program.

As earlier mentioned the hierarchy data structure can be codified using a wide variety of known-in-the-art techniques, for example a ‘C’ struct, a Java tree, or using relations in a relational database. Aspects of a hierarchy representation are presently discussed.

FIG. 2 is an annotated hierarchy diagram 200 as used in systems to implement a human interface screen device for interacting with a multi-level hierarchy. As an option, the present annotated hierarchy diagram 200 may be implemented in the context of the architecture and functionality of the embodiments described herein. Also, the annotated hierarchy diagram 200 or any aspect therein may be implemented in any desired environment.

As shown the hierarchy representation comprises a root node 201 under which are nodes arranged into Level 0 210, Level 1 211, Level 2 212, and Level 3 213. Additional levels are possible, but are not shown in the embodiment of FIG. 2. Continuing, any node at any level can comprise node information. Such node information can be stored with the node, as shown for node information 104₀. Or node information can be stored separately from the nodes of the hierarchy, for example in node information instances within a partition of node information 104 such as is shown for node information 104₁ through node information 104_{N}. A particular node can point to node information, or node information can point to a node (as shown). Furthermore, multiple nodes can point to the same node information or vice-versa.

### Displaying Levels of the Hierarchy

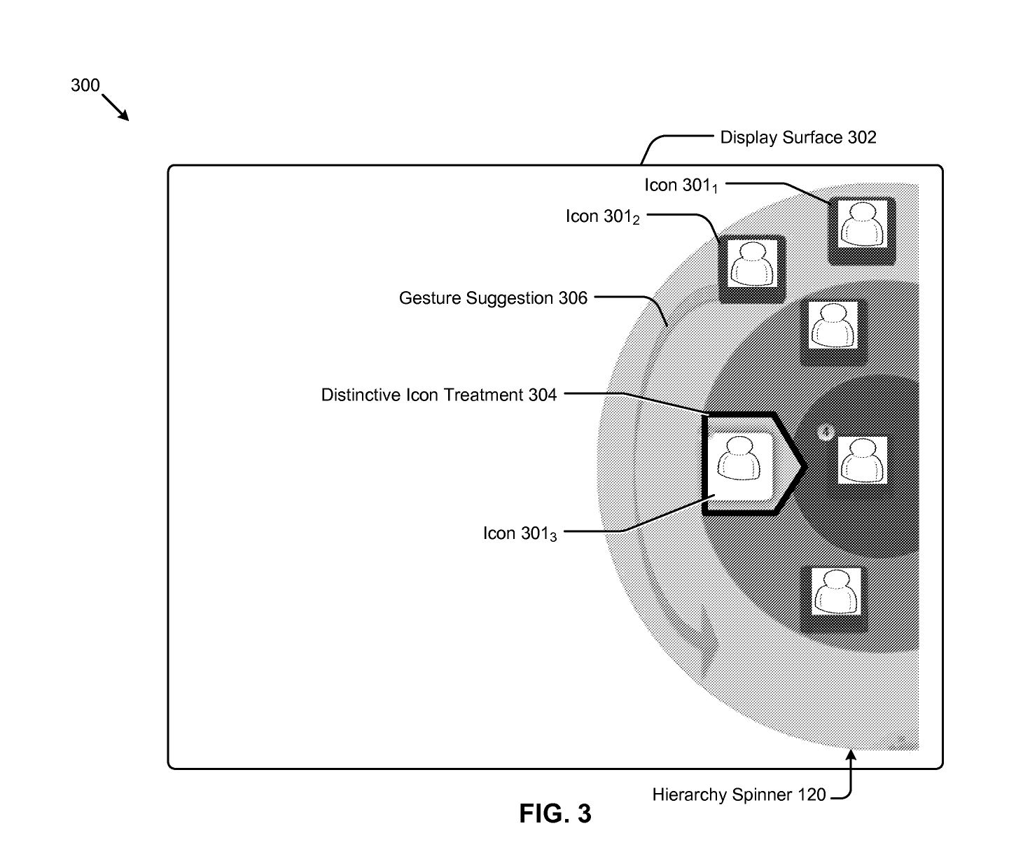

In exemplary embodiments, the hierarchy spinner displays only three levels of the hierarchy at any given time. Following this embodiment, and again referring to the specific implementation of a hierarchy data structure for representing a hierarchical org chart:
Level 0 is the topmost node, such as a CEO. Generally Level 0 of the hierarchy contains only a single entity.
Level 1 depicts employees or workers that report into the Level 0 entity, such as the CEO's direct reports. The number of entities that can be displayed in this annular area depends on many factors including screen size and resolution, the screen real estate dedicated to the hierarchy spinner, and other values (e.g., as retrieved from the configuration data 106). In exemplary embodiments for display on a tablet screen, the first annular area will contain three to four workers. It is possible that some hierarchies permit a node from a lower level of the hierarchy to be associated with more than one node in one or more levels of the hierarchy, for example in the case of a “dotted line” reporting structure” (see the dotted line reporting as shown in FIG. 2).
Level 2 represents the direct reports of a particular worker from Level 1, which particular worker can be selected by a gesture (see FIG. 3). Size permitting, it will contain five or six workers in this annular area.

Thus, the annular areas comprise concentric circles or rings in the hierarchy spinner, where each concentric circle or ring represents aspects of a respective hierarchical level. In some embodiments each concentric circle is displayed having its own respective shading and transparency level (e.g., to give a concentric ring appearance).

The views are placed in the following order from bottom to top:
a) Outer most view
b) Inner most view
c) Middle view
   Interacting with Levels of the Hierarchy

For depictions of a hierarchy spinner in the embodiment of an organizational spinner, the depiction can display the user's current hierarchy while caching any or all of the user's peers, the user's boss, the user's bosses peers, etc. In a supervisory-styled organization, user's supervisors (possibly including multiple supervisors for a given individual), and any supervisors' peers and all of their direct reports can be cached for quick access, and smooth operation of the spinner. Strictly as one example, and referring to FIG. 2, the root node 201 could have peer nodes that are cached for quick access and smooth operation of the spinner.

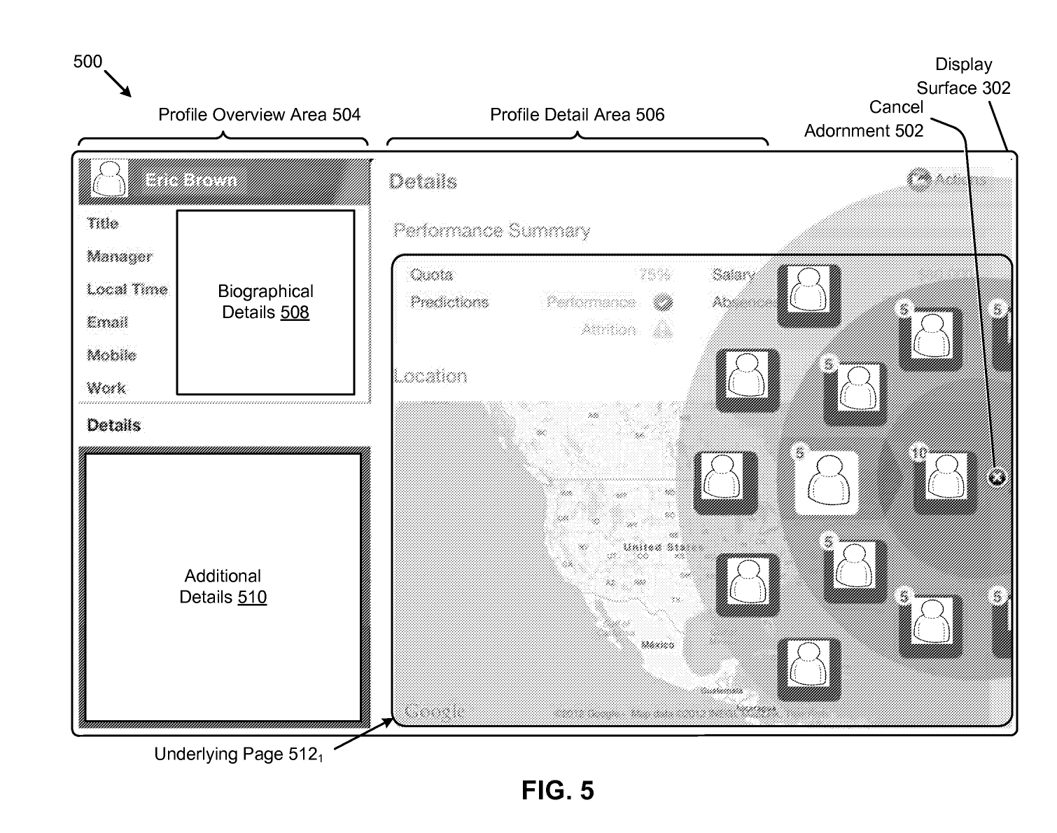

Functions of the hierarchy spinner include the ability to determine what interaction gestures are relevant to an underlying page (see FIG. 5). For example, in an organizational spinner, a single tap on a worker can bring-up a display of the worker's details, which worker's details can be displayed in the underlying page. As another example, when a user is interacting with a hierarchy spinner in the form of a product spinner, a user's single tap on a node will populate fields in the underlying page with the nodes details (e.g., product name, transaction currency, revenue contribution, etc.).

FIG. 3 depicts a partially populated hierarchy spinner displayed with a gesture suggestion on a touch-screen display surface 300 used in systems having a human interface screen device for interacting with a multi-level hierarchy. As an option, the present touch-screen display surface 300 may be implemented in the context of the architecture and functionality of the embodiments described herein. Also, the touch-screen display surface 300 or any aspect therein may be implemented in any desired environment.

### Basic Gestures and Animations

To spin a level, a swipe gesture results in one or more animations. A typical swipe would include a circular motion, substantially within the subject level, however a user interface interpreter can be inferred merely by some monotonically-upward or monotonically-downward motion during the swipe portion of the gesture.

Such a gesture serves to initiate an animation, and the characteristics of the swipe are translated to a particular velocity for spin. For example, a faster swipe would result in a faster spinning motion of the subject tapped level. The aforementioned user interface interpreter will spin the level through the frames of a damped animation, and eventually lock the spinner level into position when velocity slows below a predetermined velocity threshold.

The aforementioned interface interpreter includes a pan gesture recognizer, and such a pan gesture recognizer is implemented to track the users touch actions. For example, the touch-based spin animation is implemented based on the state of the pan gesture. Using a pan gesture, a user is able to spin nodes off of a level to see nodes that have been hidden (e.g., if or because they cannot fit in the available annular area of a particular level). For example, the outer level might only show eight nodes, but if 10 nodes are present in the hierarchical data structure for that level, two nodes will maintained in a hidden state (e.g., hidden from that level) until the user spins that level to view those hidden nodes. The previously shown eight nodes will spin off that level and go into a hidden state.

In exemplary embodiments, an interface interpreter implements a state machine, and the state variable is set to “Began” when the user initially touches the screen. The initial touch position is recorded. Subsequently, the state variable is set to “Changed” when the user moves his or her pointing finger over one of the “spinnable” annular areas. The angle, direction and speed of movement is calculated based on the difference between the initial position and the final finger position on the screen. This is then applied to the appropriate concentric annular area under the user's finger. This continues as long as the user's finger is in contact with the screen and remains on the same “spinnable” annular area. When the user lifts his or her finger off the screen the spinner will continue to spin with a velocity based on the gesture, and gradually the animation comes to a stop when it snaps into one of the predetermined positions. For example, an inner annular area might only terminate a spinning animation when the icons are 0 degrees, 90 degrees, 180 degrees, and 270 degrees. The state variable is set to “Ended” when the user lifts his or her finger off the screen. The final position and velocity of spin is recorded.

Some embodiments are subject to predetermined constraints based on aspects of configuration data 106. For example, a display surface 302 has display limitations (e.g., resolution) and can only display features within a limit. As shown, the hierarchy spinner depicts an avatar 301 (e.g., avatar 301₁, avatar 301₂, avatar 301₃, etc.) and, based on the size and position of the icon or icons, some animations can be performed in their entirety, some can be performed only partially, and some cannot be performed at all. In the example shown, Level 3 with less than seven nodes and Level 2 with less than five nodes will not be able to spin, since there are no further nodes to be displayed. For levels/rings that can spin, the level will be fully-populated.

Some embodiments present one or more visual cues and/or gesture suggestions. For example, the outer annular area of FIG. 3 depicts a twisted ribbon graphic that serves as a gesture suggestion 306. As another example, an icon can be the subject of a distinctive icon treatment 304, and such a distinctive icon treatment can be used to indicate a selected node in the hierarchy. Some distinctive icon treatments are symmetric, others are asymmetric. In a general case, an icon has a natural orientation and in order to maintain its natural orientation as the user spins the concentric rings, the icons are rotated by an amount equal to that of the spin, but in the reverse direction of the spin, thus maintaining the icon's natural orientation. Also, as shown, for conserving space on a display surface, only a portion of the graphical screen device is displayed. In the example shown, instead of displaying all portions of the concentric rings, a portion of the hierarchy spinner is “cut off” at the right side of the display surface. Certain embodiments can occlude a portion with some other screen devices such as a panel or border. The extent of the “cut-off” or occluded region can be tuned, based on the characteristics of the display surface and the objects displayed.

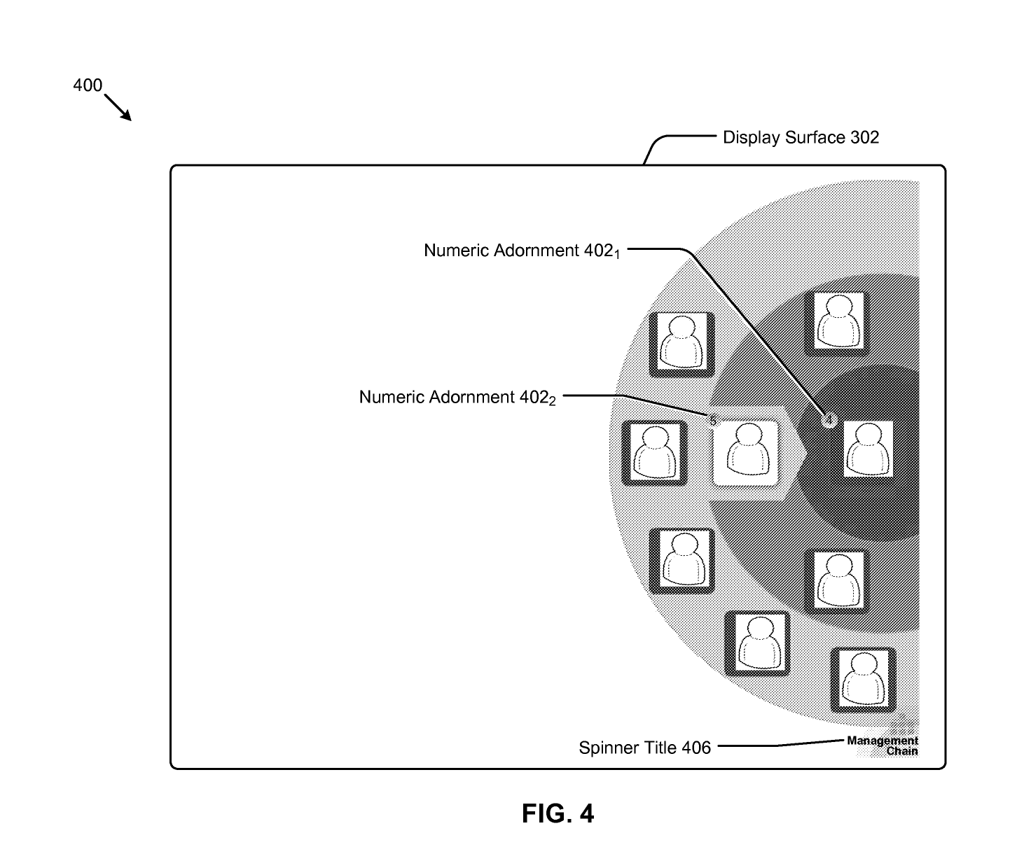

FIG. 4 depicts a hierarchy spinner displaying node data based on user gestures as depicted on a display surface 400 used in systems having a human interface screen device for interacting with a multi-level hierarchy. As an option, the present display surface 400 may be implemented in the context of the architecture and functionality of the embodiments described herein. Also, the display surface 400 or any aspect therein may be implemented in any desired environment.

As earlier mentioned, embodiments of the present disclosure serve to aid a user in moving through, interacting with and analyzing the hierarchy data structure. Accordingly, display option and navigation controls are herein disclosed.

### Graphical Adornments

As shown, the right side of display surface 302 contains a hierarchy spinner for representing a hierarchical organization, and the hierarchy spinner depicts icons with various adornments. For example, FIG. 4 depicts a numeric adornment 402₁, which numeric adornment represents the number of child nodes (e.g., direct reports). Similarly, FIG. 4 depicts another numeric adornment 402₂, which numeric adornment represents the number of children (e.g., one level lower) for that node. Further a spinner title 406 can be displayed on or near the hierarchy spinner, as shown, the spinner title 406 is “Management Chain”, as displayed in the lower right corner of the shown display surface 302.

### Navigation Controls: Up/Down and Left/Right

Gesture: Double tap on any node within the spinner:
Animation for Double Tap: Double tap Level 1 node with children:
   Level 3: Current nodes will spin downward off the screen.
   Level 2: Current nodes will move down to Level 3 and additional peer nodes will appear to show seven nodes (if available).
   Level 1: Current node will move down to the center of Level 2; Chevron will move to be positioned/centered behind the node and additional peer nodes will appear to show three nodes.
   Level 0: Parent of tapped Level 1 node will slide in from the right in the center of the Level 1 node.

Gesture: Double tap Level 1 node with no supervisor:
Level 1 node with no supervisor will not animate.

Gesture: Double tap Level 2 node with children:
Level 3: Current nodes will spin downward off the screen.
Level 3: New nodes will spin downward on the screen and a maximum of seven nodes will be displayed.
Level 2: The adornment (e.g., a border or chevron) will spin to tapped node from previously selected node.

Gesture: Double tap Level 2 node with no children:
Level 3: Current nodes will spin downward off the screen.
Level 2: Current nodes will move down to Level 3 and additional peer nodes will appear to show seven nodes (if available).
Level 1: Current node will move down to the center of Level 2; Chevron will move to be positioned/centered behind the node and additional peer nodes will appear to show three nodes.
Level 0: Parent of tapped Level 1 node will slide in from the right in the center of the Level 1 node.

Gesture: Double tap Level 3 node with children:
Level 3: Tapped node and its two adjacent peers will move up to Level 2.
Level 3: New nodes will spin downward on the screen and a maximum of seven nodes will be displayed in alpha or alphanumeric sort.
Level 2: Node within Chevron will move to the Level 1 position and peers will fade away.
Level 1: Node will fade away.

Gesture: Double tap Level 3 node with no children:
Level 3 node with no children will not animate upon a tap gesture.

FIG. 5 depicts a hierarchy spinner displayed with computer-generated data representations shown on a display surface 500 used in systems having a human interface screen device for interacting with a multi-level hierarchy. As an option, the present display surface 500 may be implemented in the context of the architecture and functionality of the embodiments described herein. Also, the display surface 500 or any aspect therein may be implemented in any desired environment.

### Viewing Node Details

As earlier indicated, a node can have associated node information 104, and such node information can be displayed within the boundary of a display surface 302. As shown the hierarchy spinner has one node selected (see the white-highlighted node), and node information is displayed for that node. In this example, node information is displayed in a profile overview area 504. Additional node information is displayed in a profile detail area 506. Of course in the example shown, the displayed node information (see biographical details 508) pertains to the selected person in the hierarchy spinner, however display of other node information for other node entities is possible and envisioned (see additional details 510).

The node information can be controlled through gestures, as follows:
Gesture: Single tap.
Animation: Details for the node will appear on the display surface, possibly by sliding in from the right, and may or may not stack semi-transparently on top of the underlying page.
Single tapped node will have their background change to white.

### Closing the Spinner

The hierarchy spinner can be closed or minimized via a touch or other gestures. For example, a user might touch a cancel adornment 502 (see the X as shown on the right side of FIG. 5). Or, a hierarchy spinner can be closed or minimized via a gesture. Specifically, the user taps away from the spinner in an area that does not contain an item. Alternatively, when a user taps on an item in the underlying page 512₁, that gesture takes the user to a new page. Such cases initiate an animation during which the hierarchical spinner fades away on the screen and closes.

Of course, the aforementioned adornments are merely examples, and adornments can comprise any visual indication on or near an icon. Moreover the features of display surfaces provide a rich environment for applying adornments to display objects, and the visual indications as used herein may use any technique where the adornment is visually distinct from a display object without an adornment.

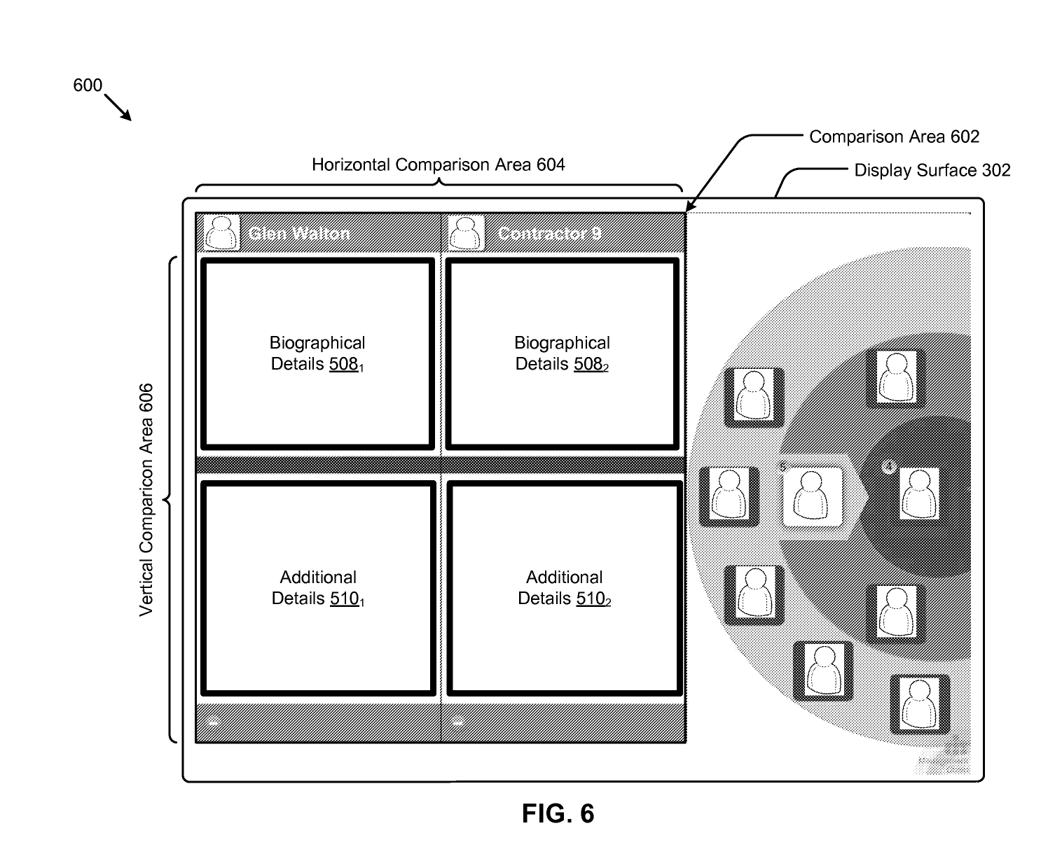

FIG. 6 depicts a hierarchy spinner displayed with side-by-side comparisons and animations upon a display surface 600 used in systems having a human interface screen device for interacting with a multi-level hierarchy. As an option, the present display surface 600 may be implemented in the context of the architecture and functionality of the embodiments described herein. Also, the display surface 600 or any aspect therein may be implemented in any desired environment.

One advantage of the herein-disclosed navigation through a hierarchy is the ease of comparing node information pertaining to one node vis-à-vis node information pertaining to another node. For example, some embodiments support side-by-side comparisons. The depiction of FIG. 6 shows node information presented in a comparison area 602. Such a comparison area can be populated with node information juxtaposed horizontally in a horizontal comparison area 604, and/or the comparison area can be populated with node information juxtaposed vertically in a vertical comparison area 606. The comparison area can be populated with node information in any form. As shown the comparison area is populated with node information with biographical details 508 (e.g., biographical details 508₁, biographical details 508₂, etc.) and/or display of other node information in the form of additional details 510 (e.g., additional details 510₁, additional details 510₂, etc.).

### Additional Gesture and Animations

Table 1 lists exemplary gestures and animations. The examples in the listing are merely a sampling of possible gestures and animations. Additional gestures and corresponding animation are possible and envisioned.

TABLE 1
Gestures and corresponding animations

| Item | Gesture | Animation |
|---|---|---|
| 1 | Tap and | All nodes in the spinner start to wiggle. |
| | Hold | Tapped node has check mark appear in the center |
| | Node for | of the node's worker or portrait thumbnail. |
| | 0.5 Seconds | Underlying right pane details slides down off the |
| | | glass. |
| | | Currently displayed worker or product summary |
| | | remains on the far left butted up against the glass, |
| | | and a set of comparables appears. |
| | | Tapped worker or product summary with |
| | | comparables slides in from the right and butts up |
| | | against already displayed worker summary. |
| 3 | User Taps | Node has check mark appear in the center of the |
| | on N# of | node's worker or portrait image. |
| | Unselected | Worker or product summary with comparables slides |
| | Nodes | in from the right and butts up against already |
| | | displayed worker summary. |
| 4 | User Taps | Node has check mark disappear from the center of |
| | on N# of | the node's worker or portrait thumbnail. |
| | Selected | Worker or product summary with comparables slides |
| | Nodes | down off the screen. |
| | | If worker or product summary exists next to the now |
| | | deselected node, then it slides from the right and butts |
| | | up against already displayed worker summary. |
| 5 | Closing a | User can close a compare summary by either tapping |
| | Compare | on the “-” symbol/adornment at the bottom-left of the |
| | Summary | summary, to the right of the worker or product name. |
| | | User can close a compare summary by tapping on an |
| | | already selected node. |
| 6 | Single Tap | Populate fields in an underlying page. |
| | on a Node | |
| 7 | Getting out | User will get out of compare mode when one selected |
| | of Compare | summary remains or when the user taps on an item in |
| | Mode | the summary that takes the user to a new page. |
| | | User will not get out of compare mode if a single tap |
| | | on an item in the summary brings up a popover menu, |
| | | swipes left or right to see additional summaries, or |
| | | taps hold and re-sorts the summaries. |

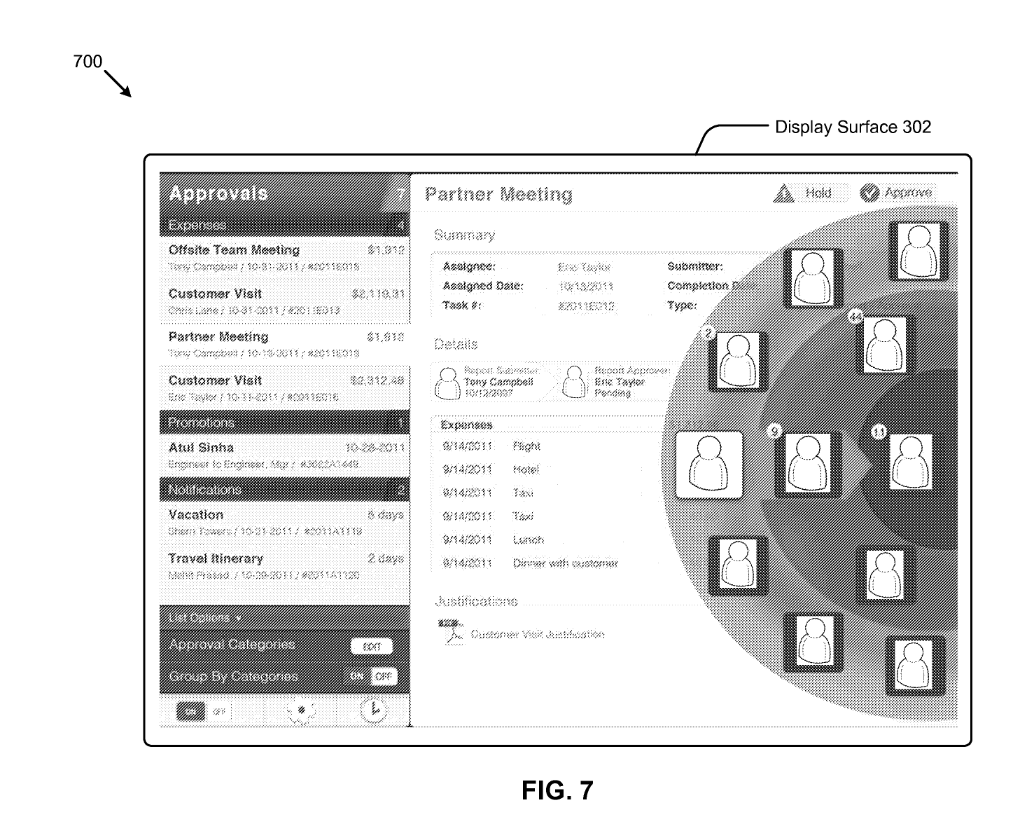

FIG. 7 depicts a hierarchy spinner displayed with computer-generated reports shown on a display surface 700 used in systems having a human interface screen device for interacting with a multi-level hierarchy. As an option, the present display surface 700 may be implemented in the context of the architecture and functionality of the embodiments described herein. Also, the display surface 700 or any aspect therein may be implemented in any desired environment.

This embodiment continues the example, showing node information in the form of biographical information pertaining to the selected node. Certain embodiments of a hierarchy spinner address usability issues in tablet-based enterprise software applications. Moreover, certain operations in some enterprise software applications rely upon large and complex hierarchies that users need to navigate with great fluidity. Examples of such complex hierarchies include product catalogs, enterprise-wide organizational charts, departmental charge number hierarchies, etc.

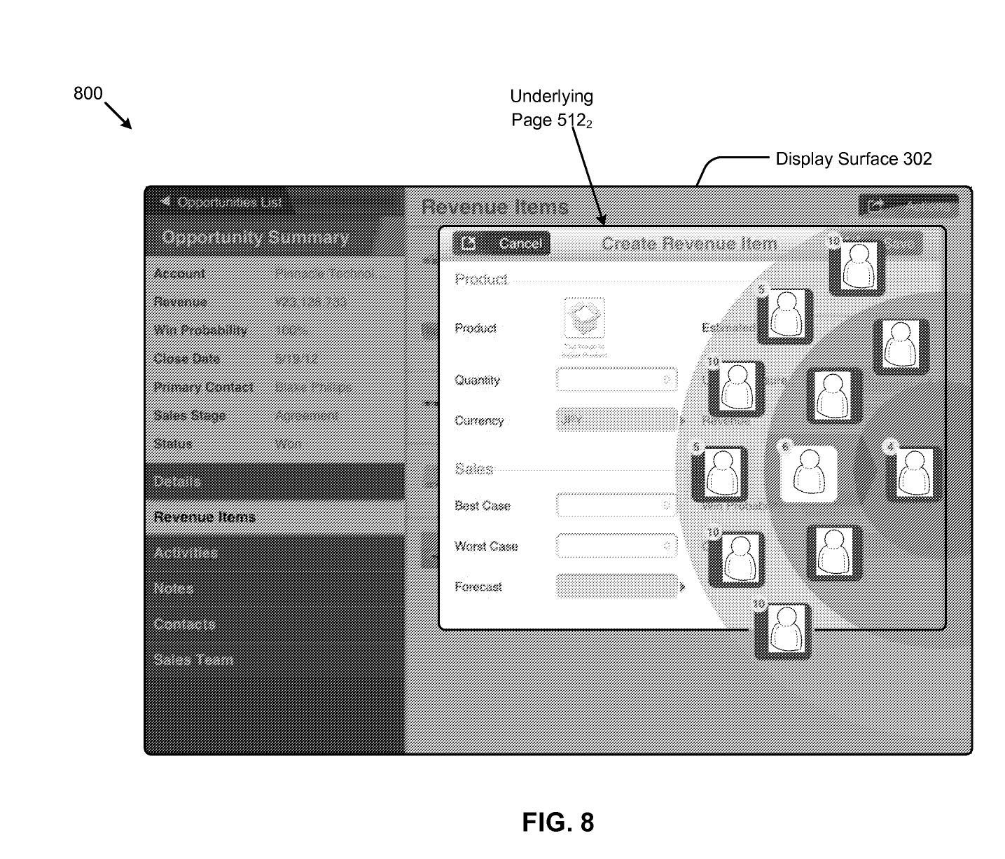

FIG. 8 depicts a hierarchy spinner displayed with an underlying page on a display surface used in systems having a human interface screen device for interacting with a multi-level hierarchy, according to some embodiments.

As shown, one possible embodiment of an underlying page 512₂ is displayed as a response to a user gesture of a single tap on a node. In this specific example, a single tap on the node with numeric decoration “6” brings up the underlying page 512₂ showing a “Create Revenue Item” entry form. A single tap on another node would bring up an underlying page 512₂, possibly populated with context-sensitive data.

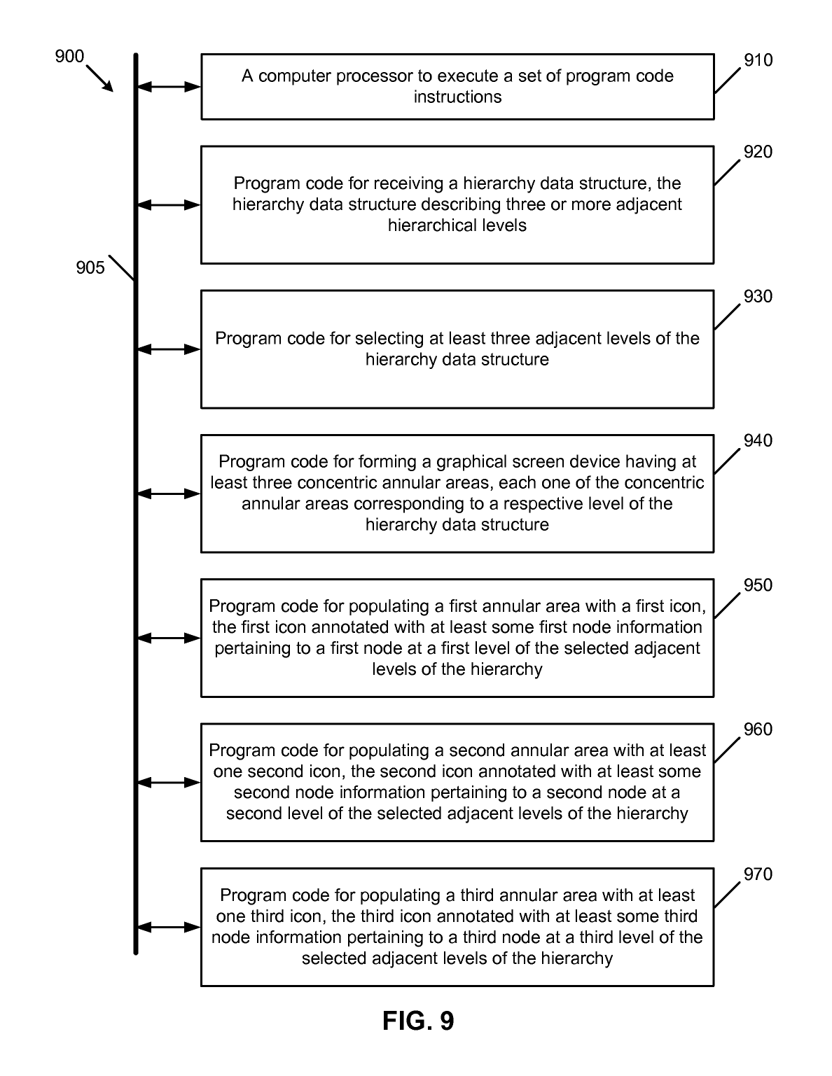

FIG. 9 depicts a block diagram of a system to perform certain functions of a computer system. As an option, the present system 900 may be implemented in the context of the architecture and functionality of the embodiments described herein. Of course, however, the system 900 or any operation therein may be carried out in any desired environment. As shown, system 900 comprises at least one processor and at least one memory, the memory serving to store program instructions corresponding to the operations of the system. As shown, an operation can be implemented in whole or in part using program instructions accessible by a module. The modules are connected to a communication path 905, and any operation can communicate with other operations over communication path 905. The modules of the system can, individually or in combination, perform method operations within system 900. Any operations performed within system 900 may be performed in any order unless as may be specified in the claims. The embodiment of FIG. 9 implements a portion of a computer system, shown as system 900, comprising a computer processor to execute a set of program code instructions (see module 910) and modules for accessing memory to hold program code instructions to perform: receiving a hierarchy data structure, the hierarchy data structure describing three or more adjacent hierarchical levels (see module 920); selecting at least three adjacent levels of the hierarchy data structure (see module 930); forming a graphical screen device having at least three concentric annular areas (see module 940); populating a first annular area with a first icon, the first icon annotated with at least some first node information pertaining to a first node at a first level of the selected adjacent levels of the hierarchy (see module 950); populating a second concentric area with at least one second icon, the second icon annotated with at least some second node information pertaining to a second node at a second level of the selected adjacent levels of the hierarchy (see module 960); and populating a third annular area with at least one third icon, the third icon annotated with at least some third node information pertaining to a third node at a third level of the selected adjacent levels of the hierarchy (see module 970).

### System Architecture Overview

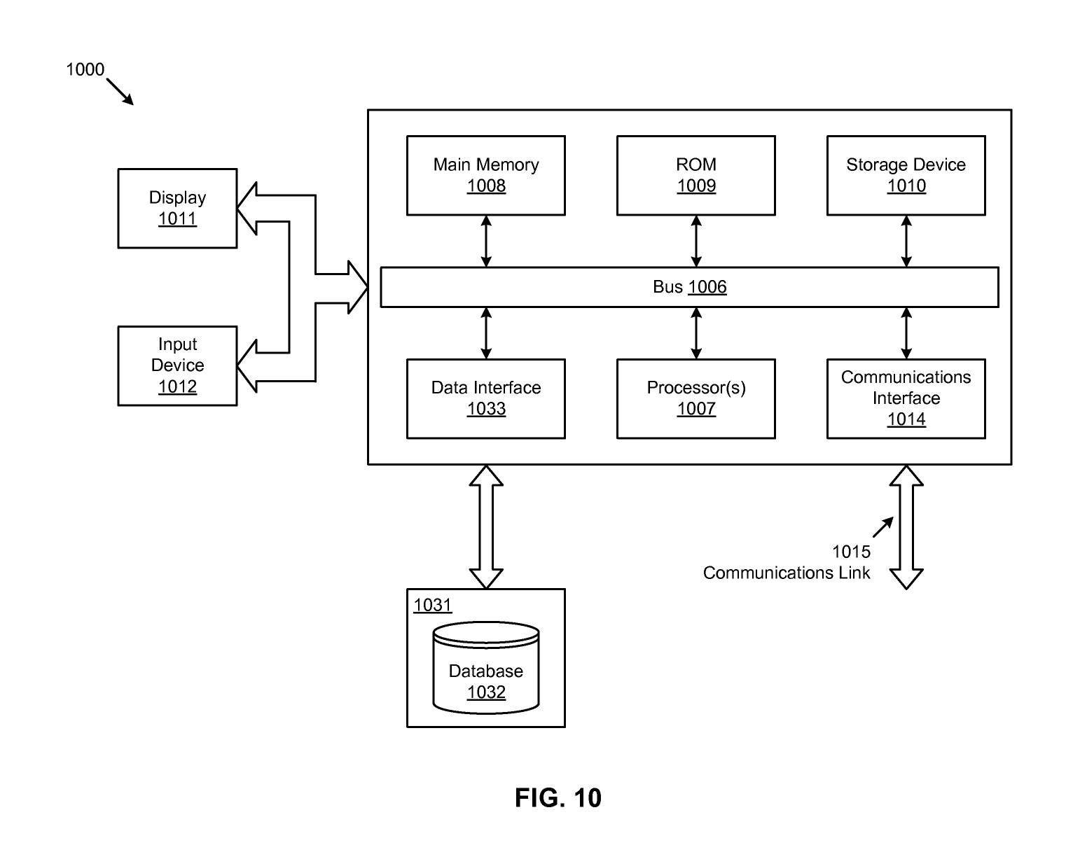

FIG. 10 depicts a block diagram of an instance of a computer system 1000 suitable for implementing an embodiment of the present disclosure. Computer system 1000 includes a bus 1006 or other communication mechanism for communicating information, which interconnects subsystems and devices, such as a processor 1007, a system memory 1008 (e.g., RAM), a static storage device (e.g., ROM 1009), a disk drive 1010 (e.g., magnetic or optical), a data interface 1033, a communication interface 1014 (e.g., modem or Ethernet card), a display 1011 (e.g., CRT or LCD), input devices 1012 (e.g., keyboard, cursor control), and an external data repository 1031.

According to one embodiment of the disclosure, computer system 1000 performs specific operations by processor 1007 executing one or more sequences of one or more instructions contained in system memory 1008. Such instructions may be read into system memory 1008 from another computer readable/usable medium, such as a static storage device or a disk drive 1010. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 1007 for execution. Such a medium may take many forms, including but not limited to, non-volatile media and volatile media. Non-volatile media includes, for example, optical or magnetic disks, such as disk drive 1010. Volatile media includes dynamic memory, such as system memory 1008.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 1000. According to certain embodiments of the disclosure, two or more computer systems 1000 coupled by a communications link 1015 (e.g., LAN, PTSN, or wireless network) may perform the sequence of instructions required to practice the disclosure in coordination with one another.

Computer system 1000 may transmit and receive messages, data, and instructions, including programs (e.g., application code), through communications link 1015 and communication interface 1014. Received program code may be executed by processor 1007 as it is received, and/or stored in disk drive 1010 or other non-volatile storage for later execution. Computer system 1000 may communicate through a data interface 1033 to a database 1032 on an external data repository 1031. A module as used herein can be implemented using any mix of any portions of the system memory 1008, and any extent of hard-wired circuitry including hard-wired circuitry embodied as a processor 1007.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than restrictive sense.

What is claimed is:

1. A computer implemented method for composing a human interface screen device for interacting with a multi-level hierarchy, the method comprising:
receiving, by a computer, a hierarchy data structure, the hierarchy data structure describing a plurality of adjacent hierarchical levels;
selecting at least two of the plurality of adjacent hierarchical levels of the hierarchy data structure;
forming a graphical screen device having a plurality of concentric areas, each one of the concentric areas corresponding to a respective level of the hierarchy data structure;
populating a first concentric area with at least some first node information pertaining to a first level of the selected adjacent hierarchical levels; and
populating a second concentric area with at least some second node information pertaining to a second node at a second level of the selected adjacent hierarchical levels.

2. The method of claim 1, wherein the first concentric area forms at least one of, a circle, or a ring.

3. The method of claim 1, wherein a third level of the selected adjacent hierarchical levels is at an adjacent lower level of the hierarchy than is the second level of the selected adjacent hierarchical levels.

4. The method of claim 1, further comprising a plurality of icons within the first concentric area having a visual indication on at least one icon, the visual indication on the at least one icon being visually distinct from a visual indication on any of the remainder of the plurality of icons

5. The method of claim 1, further comprising displaying, on a display surface, a portion of the graphical screen device.

6. The method of claim 1, further comprising at least one of, an animation of at least one of the concentric areas, a gesture suggestion, a profile overview area, a profile detail area, or a comparison area.

7. The method of claim 1, further comprising at least one of, a numeric adornment, a cancel adornment.

8. A computer system for a human interface screen device for interacting with a multi-level hierarchy, comprising:
a computer processor to execute a set of program code instructions; and
a memory to hold the program code instructions, in which the program code instructions comprises program code to perform,
receiving a hierarchy data structure, the hierarchy data structure describing a plurality of adjacent hierarchical levels;
selecting at least two of the plurality of adjacent hierarchical levels of the hierarchy data structure;
forming a graphical screen device having a plurality of concentric areas, each one of the concentric areas corresponding to a respective level of the hierarchy data structure;
populating a first concentric area with at least some first node information pertaining to a first level of the selected adjacent hierarchical levels; and
populating a second concentric area with at least some second node information pertaining to a second node at a second level of the selected adjacent hierarchical levels.

9. The computer system of claim 8, wherein the first concentric area forms at least one of, a circle, or a ring.

10. The computer system of claim 8, wherein a third level of the selected adjacent hierarchical levels is at an adjacent lower level of the hierarchy than is the second level of the selected adjacent hierarchical levels.

11. The computer system of claim 8, further comprising a plurality of icons within the first concentric area having a visual indication on at least one icon, the visual indication on the at least one icon being visually distinct from a visual indication on any of the remainder of the plurality of icons

12. The computer system of claim 8, further comprising displaying, on a display surface, a portion of the graphical screen device.

13. The computer system of claim 8, further comprising at least one of, an animation of at least one of the concentric areas, a gesture suggestion, a profile overview area, a profile detail area, or a comparison area.

14. The computer system of claim 8, further comprising at least one of, a numeric adornment, a cancel adornment.

15. A computer program product embodied in a non-transitory computer readable medium, the computer readable medium having stored thereon a sequence of instructions which, when executed by a processor causes the processor to execute a process to implement a human interface screen device for interacting with a multi-level hierarchy, the process comprising:
receiving a hierarchy data structure, the hierarchy data structure describing a plurality of adjacent hierarchical levels;
selecting at least two of the plurality of adjacent hierarchical levels of the hierarchy data structure;
forming a graphical screen device having a plurality of concentric areas, each one of the concentric areas corresponding to a respective level of the hierarchy data structure;
populating a first concentric area with at least some first node information pertaining to a first level of the selected adjacent hierarchical levels; and
populating a second concentric area with at least some second node information pertaining to a second node at a second level of the selected adjacent hierarchical levels.

16. The computer program product of claim 15, wherein the first concentric area forms at least one of, a circle, or a ring.

17. The computer program product of claim 15, wherein a third level of the selected adjacent hierarchical levels is at an adjacent lower level of the hierarchy than is the second level of the selected adjacent hierarchical levels.

18. The computer program product of claim 15, further comprising a plurality of icons within the first concentric area having a visual indication on at least one icon, the visual indication on the at least one icon being visually distinct from a visual indication on any of the remainder of the plurality of icons

19. The computer program product of claim 15, further comprising displaying, on a display surface, a portion of the graphical screen device.

20. The computer program product of claim 15, further comprising at least one of, an animation of at least one of the concentric areas, a gesture suggestion, a profile overview area, a profile detail area, or a comparison area.
